(19) United States
(12) Patent Application Publication
(10) Pub. No.: US 2001/0050816 A1
(43) Pub. Date: Dec. 13, 2001

(54) SPREAD ILLUMINATING APPARATUS

(76) Inventors: SHINGO SUZUKI, ASABA-CHO (JP); MASAFUMI OKADA, ASABA-CHO (JP); KOICHI TOYODA, ASABA-CHO (JP)

Correspondence Address: OLIFF & BERRIDGE PLC, P.O. BOX 19928, ALEXANDRIA, VA, 22320

(21) Appl. No.: 09/456,442

(22) Filed: Dec. 8, 1999

(30) Foreign Application Priority Data
Feb. 9, 1999 (JP) 11-031414

(51) Int. Cl. G02B 5/02; G02B 13/20

(52) U.S. Cl. 359/599

(57) ABSTRACT

Between the transparent substrate 2 and the light source portion 4, the light diffusion film 20 to diffuse the light as the light diffusion layer is interposed. Thereby, the lights emitted from the light source 4 different in brightness, due to the diffusion during progressing in the light diffusion film 20, at the process of entering the transparent substrate 2, becomes even in brightness, and is suspended in the generation of the stripe pattern of light and shade, as a result a spread and even illumination can be realized.

### BACKGROUND OF THE INVENTION

1. Field of the Invention

The present invention relates to a spread illuminating apparatus for use of illuminating a signboard and various kinds of reflection type of display, in particular, a liquid crystal display apparatus.

2. Related Arts

As an auxiliary illuminating apparatus for illuminating the surface of a reflection type of a liquid crystal display element, in FIG. 7 a spread illuminating apparatus (Japanese Patent Application number Hei 10-182076) created by the inventors of the present invention is explained. Further, this spread illuminating apparatus 1′ is indicated as a prior art. The spread illuminating apparatus 1′ is used and disposed for covering a front F of a liquid crystal display element L. And, it comprises a transparent substrate 2 which is made of a material having a high light-transparency and plane and sectionally rectangular and a light source 4 disposed at the side 3 of the substrate 2. And, the transparent substrate 2 may happen to be wedge-like in configuration in order to become light-weighted.

Here, in FIG. 7 the surface of the transparent substrate 2 to be touched to the reflection type of liquid crystal display element L is to be called a lower surface 5 and its reverse surface is to be called an upper surface 6 (front surface) as an observation surface (picture).

The light source 4, as shown in FIG. 8, consists of a bar-like (or linear) light conductive member 7 and a spot-like light source 9 such as a light emitting diode disposed on both ends of the bar-like light conductive member 7. On one surface 14 of the light conductive member 7 an optical path conversion member 11 to be explained in detail later is disposed, and further, a longitudinal surfaces except the surface to be faced to the transparent substrate 2 are covered with reflection member (reflector) 12 to introduce the light progressing within the light conductive member 7 to the transparent substrate 2 with a high efficiency.

The optical path conversion member 11 is formed on the surface 14 opposite to the surface 13 opposing to the side 3 of the transparent substrate 2 definition, the surface of which are formed with a combination of a finely rough light diffusion portion i.e. roughened portion 15 (a black portion in FIG. 8) and a plane portion 16 not roughened. Due to the formation of finely rough portion, since the light reflected on the light diffusion portion 15 becomes more than the plane portion 16 in the amount of the light to be incident into the substrate 2, in proportion to the distance from the spot-like light source 9, the area of the light diffusion portion 15 is adapted to become large. Since, by forming the optical path conversion means 11 is formed in consideration of the balance of the distance from the spot-like light source 9 and the area of the light diffusion portion 15, although the spot-like light source 9 is disposed at the end portion 8 of the light conductive member 7, the light is emitted even from the side 13 opposing to one side 3 of the transparent substrate 2, wherein the light source 4 which is constituted of a spot-like light source 9 and the light conductive member 7 functions as well as a fluorescent lamp as a bar-like light source (e.g. cold cathode fluorescent lamp, hot cathode fluorescent lamp).

And, on the upper surface 6 of the transparent substrate 2, a light reflection pattern 17 is formed. The light reflection pattern 17 is formed along the one side 3, and which comprises a plurality of triangular grooves 18 in section and a plurality of plane portions 19 adjacent to that groove 18. The light reflection pattern 17, regardless the distance from the light source 4, in order to realize an evenly spread emission from the transparent substrate 2 a spacing where the grooves 18 are provided is differentiated depending on the portions. That is, a ratio of the width (occupied area) of the groove 18 to the width (occupied area) plane portion 19 is settled in such a manner as it becomes gradually larger as far as it departs from the side 3 of the transparent substrate 2. Now, in FIG. 7, an indication of a reflection member for increasing the illuminating light volume is omitted.

When disposing the thus constituted spread illuminating apparatus 1′ on the upper surface so as to cover the reflection type of liquid crystal display element L, the light emitted from the light source 4 enters into the transparent substrate 2 from the side 3 and progresses toward the opposite surface 10 while repeating reflections and refractions within the transparent substrate 2.

In the meantime, the light emitted from the lower surface 5 of the transparent substrate 2 illuminates the reflection type of liquid crystal display element L to brighten the display surface. Then, due to the provision of the light reflection pattern 17, the volume of the light emitted from the lower surface 5 is approximately even regardless of the distance from the light source 4, so that the reflection type of liquid crystal display element L is illuminated in a spread manner.

For reference, in FIGS. 7 and 8, although the spot-like light source 9 is disposed respectively at both ends 8, 8 of the light conductive member 7, those may be either one disposed at either end 8. And, it is also disclosed that the optical path conversion means 11 to be formed on the light conductive member 7 may be formed, in addition to forming it with the light diffusion portion 15 being formed with finely roughened surface and the plane portion 16, in such a manner as it consists of a portion to be applied with media including light diffusing or reflecting materials and a portion not to be applied with such materials or of a portion which is provided with grooves cut with such angle as the reflected light becomes incident into the transparent substrate 2 and a portion not to be cut.

By the way, since the spread illuminating apparatus 1′ is formed with the light source 4 comprising the light conductive member 7 and the spot-like light source 9, there are following problems.

That is, when observing the picture of the liquid crystal display element L through the above mentioned spread illuminating apparatus 1′ which covers the observation face F of the liquid crystal display element L, it has been found that there may be an occasion where some stripe patterns of light and shade crossing right to the side 3 are generated, so that, since evenly spread illumination can not be realized, it is hard to observe the picture.

For reference, since the grooves 18 of the light reflection pattern 17 formed on the transparent substrate 2 are quite fine, those are not recognized in observing the picture.

This stripe pattern of light and shade has been found to have been caused by the optical path conversion means 11. That is, the light reflected on the light diffusion portion 15 provided on the light conductive member 7 is mainly emitted from a surface 13 and progressed into the transparent substrate 2, but the light reflected on the plane portion 16 is mostly reflected by all-reflection and is not emitted from the surface 13, so that at the surface 13 the brightness of the light emitted from the surface 13 becomes uneven due to the settled condition of the pattern formed with the light diffusion portion 15 and the plane portion 16. In that case, since the brightness of the light to enter into the transparent substrate 2 is uneven, on the display surface the stripe pattern of light and shade crossing right to the one side 3 is adapted to be generated.

Therefore, although there is an idea of fining the patterns of the light diffusion portion 15 and the plane portion 16 of the optical path conversion means 11 to the extent of unrecognition of the stripe pattern of light and shade, due to the difficulty of working, it can not be employed.

Accordingly, the present invention is made, in order to provide an apparatus in which the brightness of the light to enter the transparent substrate is made even and an evenly spread illumination is realized.

### SUMMARY OF THE INVENTION

As means to solve the above problem, according to a first aspect of the present invention, in a side light system of spread illuminating apparatus in which a bar-like light conductive member, at one end of which a spot-like light source is disposed, is put by the side of a transparent substrate, a light diffusion layer to diffuse the light is interposed between the transparent substrate and the light source.

According to a second aspect of the present invention, in the first aspect, said diffusion layer is a light diffusion film which may be thin in thickness and able to reflect the light.

According to a third aspect of the present invention, in the second aspect, wherein said light diffusion film is formed by applying a light diffusion portion containing light diffusing materials to a supporting body.

According to a fourth aspect of the present invention, in the second aspect, said light diffusion film is a thin film a surface of which is formed with a finely concavo-convex surface.

According to a fifth aspect of the present invention, in the second aspect, said light diffusion film is a thin film which is involved with light diffusing materials.

According to a sixth aspect of the present invention, in the first aspect, said light diffusion layer is formed at the side of the transparent substrate opposing to the light source.

According to a seventh aspect of the present invention, in the first aspect, said light diffusion layer is formed at the side of the light conductive member opposing to the transparent substrate.

According to an eighth aspect of the present invention, in the sixth or seventh aspect, said light diffusion layer is formed on the side with a light diffusion portion containing light diffusing or reflecting materials.

According to an ninth aspect of the present invention, in the sixth or seventh aspect, said light diffusion layer is formed with finely concavo-convex surface on the side thereof.

According to the above features, in the spread illuminating apparatus of the present invention, between the transparent substrate and the light source, a light diffusion layer is interposed, so that, though the light emitted from the light source is different in brightness, it is diffused during processing within the diffusion layer. Therefore, at the process of entering the transparent substrate the brightness of the light becomes even to suspend the generation of the stripe patterns of light and shade.

### BRIEF DESCRIPTION OF THE DRAWINGS

FIG. 1 is a broken and perspective view of a spread illuminating apparatus showing an embodiment of the present invention.

FIG. 2 is a sectional view of the light diffusion film as a main portion of the present invention.

FIG. 3 is a sectional view illustrating another main portion of the light diffusion film different from FIG. 2.

FIG. 4 is a sectional view illustrating another main portion of the light diffusion film different from FIG. 3.

FIG. 5 is a broken and perspective view of a spread illuminating apparatus showing another embodiment different from FIG. 1.

FIG. 6 is a broken and perspective view of a spread illuminating apparatus showing another embodiment different from FIG. 5.

FIG. 7 is a sectional view of a conventional spread illuminating apparatus.

FIG. 8 is a broken and perspective view of a light source of FIG. 7.

### EMBODIMENT

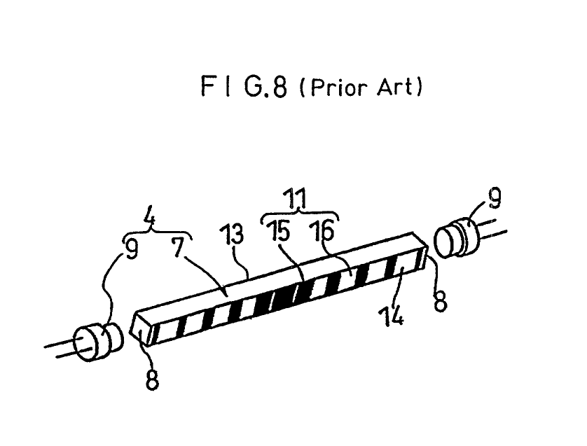

Hereinafter, an embodiment of a spread illuminating apparatus of the present invention is explained based on the attached drawing. For reference, signs used in the explanation of conventional spread illuminating apparatus 1′ of FIGS. 7 and 8 are used identically with the corresponding portions and explanation thereof are omitted.

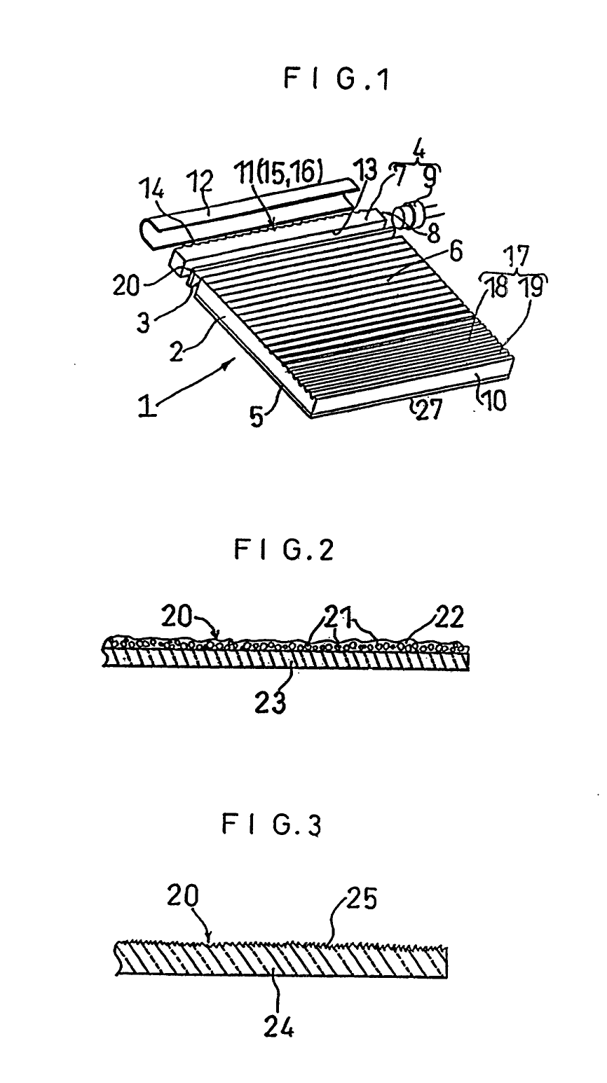

As shown in FIG. 1, the structure of the spread illuminating apparatus 1 of the present invention is approximately identical with the conventional one 1′, and its main constitution resides in the transparent substrate 2 and the light source, and difference resides in that between the transparent substrate 2 and the light source 4 a light diffusion film 20 as a light diffusion layer to diffuse the light is provided.

The light diffusion film 20, as shown in FIG. 2, is formed in such a manner as a light diffusion portion 22 including light diffusing or reflecting materials 21 are formed on a supporting body 23 of a thin plate. Due to the disposition of this light diffusion film 20, the light of the light source 4 to be emitted from the surface 13 of the light conductive member 7 may be diffused during progressing within the light diffusion film 20, and can make the brightness of the light incident from the side 3 of the transparent substrate 2 approximately even, which can prevent the stripe patterns of light and shade from being generated, which conventionally has been generated on the transparent substrate 2.

Concretely, in the case where the light conductive member 7 having 1 mm in thickness and 3 mm in width and being formed with the optical path conversion means 11 consisting of the light diffusion portion 15 with grooves which are disposed at a spacing of 0.5 mm having the reflection angle in such a manner those are set to reflect the light at such angle as to enter into the transparent substrate 2, the light diffusion film 20 is formed on a film of a polyester having 0.1 mm in thickness as the supporting body 23, in such a manner a light diffusion portion 22 is formed by coating with acrylicbeads having an average particle size of 6 μm as light diffusing or reflecting materials 21, and at this time, if the containing volume of the acrylic beads is set in such a manner as the haze value becomes 90%, and as a result, an even and spread illumination can be realized.

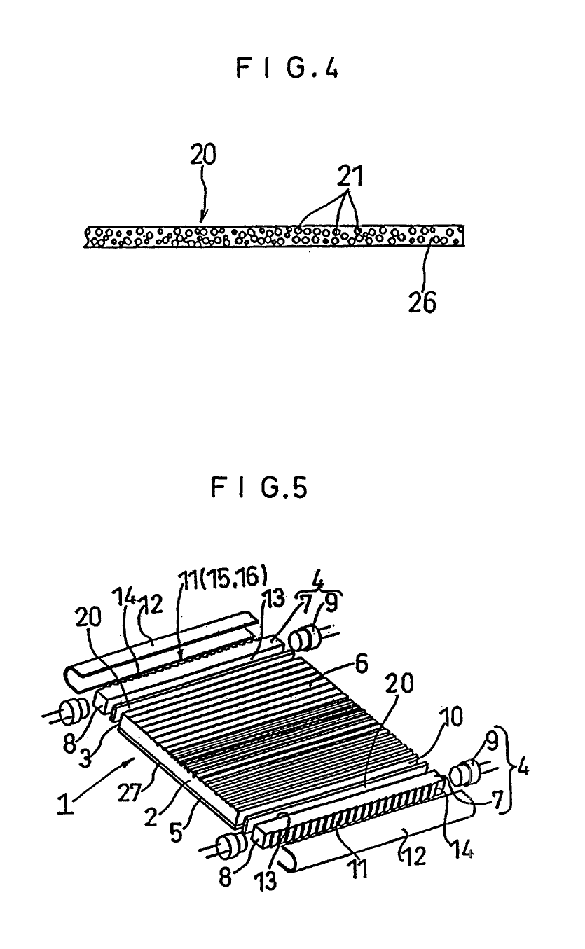

FIG. 3 shows another embodiment of the light diffusion flim 20 which is formed by making a finely concavo-convex face 25 on the surface of a thin plate 24. Further, FIG. 4 shows still another embodiment of the light diffusion film 20, that is a thin film 26 containing light diffusing or reflecting materials 21.

For reference, under the lower surface 5 of the transparent substrate 2, a transparent reflection preventing member 27 such as AR film (anti-reflection film) is adapted to be interposed between the transparent substrate 2 and the display surface F of the reflection type of liquid crystal display element L. Thereby, the contrast degradation of the picture (whitening of the picture), which is caused by the Fresnel reflection at the time of observing the display surface F of the reflection type of liquid crystal display element L under a bright circumstance around the observer, is suspended.

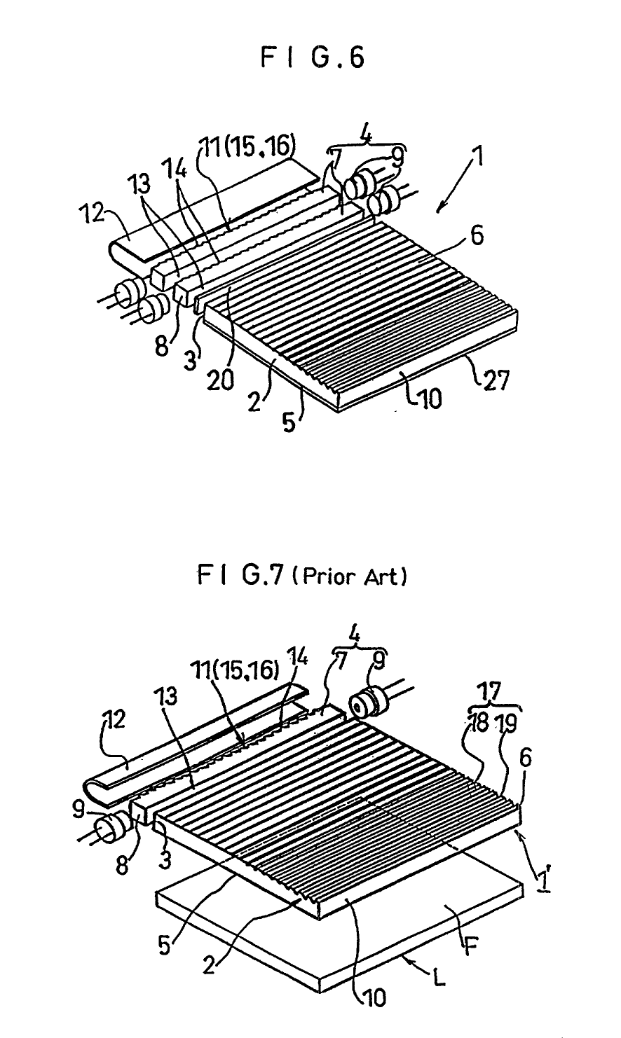

Further, as shown in FIGS. 5 and 6, in the case where the spread illuminating apparatus 1 is prepared by the provision of any additional light source portion 4 upon request in order to increase the brightness, by interposing a light diffusion film 20 between the light source portion 4 and the transparent substrate 2, an even and spread light emission for illumination can be realized.

In place of disposing the light diffusion film 20, by forming a light diffusion layer directly on one side end 3 of the transparent substrate 2, the same effect as the light diffusion film 20 is expected, which contributes to reduce the number of parts to be used. Concretely, a light diffusion portion containing the light diffusing or reflecting materials is formed on the side 3, otherwise, a finely concavo-convex face may be formed on the side 3. Further, in order to obtain the same effect, on the surface 13 of the light conductive member 7 the light diffusion layer may be directly formed, however, in this case, in consideration of the design of pattern of the optical path conversion member 11 formed on the surface 14, it has to become even at the position where the light is emitted from the surface 13.

As explained above, according to the first aspect of the spread illuminating apparatus, since the light diffusion layer to diffuse the light is provided between the transparent substrate and the light source portion, the lights different in brightness to be emitted from the light source portion are diffused while progressing in the light diffusion layer, so that, at the process of entering the transparent substrate, those will become even in brightness, and, while suspending the generation of the stripe patterns of light and shade on the transparent substrate, the evenly spread illumination can be realized.

According to the second aspect of the present invention, in addition to the same effect in the first aspect, since the light diffusion layer is made as a light diffusion film of a thin diffusion film, due to the handling easiness, the productivity such as assembling is improved.

As to the third-fifth aspects of the present invention, even if the constitution of the light diffusion film is changed in various manners, the same effect is expected as mentioned above.

According to the sixth and seventh aspects of the present invention, in addition to the same effect in the first aspect, since the light diffusion layer is formed in a unitary manner with the transparent substrate or the light conductive member, the number of parts to be used and the number of assembling processes can be reduced.

As well as in the inventions of the eighth and ninth aspects, even if the constitution of the light diffusion layer is varied in various manners, the same effect as mentioned above can be obtained.

What is claimed is:

1. A spread illuminating apparatus characterized in that, in a side light system of spread illuminating apparatus in which a bar-like light conductive member, at one end of which a spot-like light source is disposed, is put by the side of a transparent substrate, a light diffusion layer to diffuse the light is interposed between the transparent substrate and the spot-like light source.

2. A spread illuminating apparatus according to claim 1, wherein said diffusion layer is a light diffusion film which is thin in thickness and able to diffuse the light.

3. A spread illuminating apparatus according to claim 2, wherein said light diffusion film is formed by being formed with a light diffusion portion containing the light diffusing or reflecting materials applied to a supporting body.

4. A spread illuminating apparatus according to claim 2, wherein the light diffusion film is a thin film on the surface of which a finely concavo-convex face is formed.

5. A spread illuminating apparatus according to claim 2, wherein the light diffusion film is a thin film containing the light diffusing or reflecting materials.

6. A spread illuminating apparatus according to claim 1, wherein said light diffusion layer is formed on a side of the transparent substrate opposing to the side of the light source.

7. A spread illuminating apparatus according to claim 1, wherein said light diffusion layer is formed on a side of a light conductive member opposing to the transparent substrate.

8. A spread illuminating apparatus according to claim 6 or 7, wherein said light diffusion layer on one side of which is formed with a light diffusion portion containing the light diffusing or reflecting materials on one side thereof.

9. A spread illuminating apparatus according to claim 6 or 7, wherein said light diffusion layer is formed with a finely concavo-convex face on one side thereof.
